(19) United States
(12) Patent Application Publication
(10) Pub. No.: US 2018/0212825 A1
(43) Pub. Date: Jul. 26, 2018

(54) DYNAMIC MANAGEMENT OF NETWORKS TO FACILITATE STORAGE DEVICE ACCESS

(71) Applicant: OSNEXUS Corporation, Bellevue, WA (US)

(72) Inventors: Steven Umbehocker, Mercer Island, WA (US); Jayaraman Iyer, Bellevue, WA (US); Chun-Wei Chen, Bellevue, WA (US)

(21) Appl. No.: 15/879,313

(22) Filed: Jan. 24, 2018

Related U.S. Application Data
(60) Provisional application No. 62/450,026, filed on Jan. 24, 2017.

(51) Int. Cl. H04L 12/24; H04L 29/08

(52) U.S. Cl. CPC H04L 41/0806; H04L 41/12; H04L 67/1097

(57) ABSTRACT

Facilitating dynamic management of networks to facilitate storage device access is presented herein. A discovery component can discover a network topology utilizing application programming interfaces (APIs) of storage devices, network switches, and servers comprising a client computing resource in response to receiving an API request to facilitate a network access between the client computing resource and a storage device of the storage devices. Further, using the network topology, the discovery component can generate a network graph representing a physical and logical connectivity between the client computing resource and the storage device. A graph analysis component can determine, using the network graph, that an available connectivity between the client computing resource and the storage device has not been configured. Based on such determination, a configuration component can facilitate, via the APIs, respective configurations of the storage device, the network switches, and/or the client computing resource to enable the network access.

### PRIORITY CLAIM

This patent application claims priority to U.S. Provisional Patent Application Ser. No. 62/450,026, filed on Jan. 24, 2017, entitled “DYNAMIC MANAGEMENT OF STORAGE ACCESS IN A GLOBALLY DISTRIBUTED CLOUD ENVIRONMENT”, the entirety of which application is hereby incorporated by reference herein.

### TECHNICAL FIELD

This disclosure relates generally to management of storage access, but not limited to, dynamic management of networks to facilitate storage device access.

### BACKGROUND

The proliferation of cloud based storage access has increased the complexity of management of such access. Consequently, conventional network storage technologies have had some drawbacks, some of which may be noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a network storage environment, in accordance with various example embodiments;

FIG. 2 illustrates a block diagram of a storage network access control service component, in accordance with various example embodiments;

FIG. 3 illustrates a block diagram of a network storage environment having different storage zones and client networks, in accordance with various example embodiments;

FIGS. 4-9 illustrate flow diagrams of a method associated with a storage network access control service component, in accordance with various example embodiments; and

FIG. 10 illustrates a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

The proliferation of cloud computing and storage services has subsequently increased an amount of data being accessed via the cloud, and has increased the complexity of management of such access. Various embodiments described herein can dynamically manage network(s)—on behalf of a network service provider—to facilitate access, secure network access, etc. of a storage device by a computing device, server, etc. of a client of the network service provider.

In this regard, in various embodiments disclosed herein, a storage network access and control service installed in a memory of a system, server, etc. of the network service provider can utilize open source and/or vendor specific application programming interfaces (APIs) to dynamically discover and configure respective devices (e.g., storage devices, network switches, client computing devices, etc.) of a storage fabric of a public/private storage network to facilitate an access, by a client computing device, of a storage device of such network.

For example, a cloud service provider system can comprise a storage network access control service component comprising a discovery component, a graph analysis component, a configuration component, and a security analysis component. The discovery component can discover a network topology utilizing respective application programming interfaces (APIs) of storage devices, network switches, and servers of client networks—the servers comprising a client computing resource, e.g., a server, a virtual machine, etc.—in response to receiving an application programming interface (API) request to facilitate an access, a network access, a secure network access, etc. between the client computing resource and a storage device of the storage devices, e.g., a block storage device, a storage appliance, a virtual storage appliance, a resource of the storage appliance, e.g., a storage block device, a file storage device, a storage file share, etc.

In an embodiment, the API request can comprise an account identifier (ID) corresponding to the client computing resource; a network ID corresponding to the client network, e.g., a virtual local area network (VLAN) ID representing a VLAN of the client network, an Internet protocol (IP) address corresponding to the client computing resource, etc.; a compute asset ID representing the client computing resource (e.g., an Internet Small Computer System Interface (iSCSI) qualified name (IQN) representing an address of the client computing resource, a fully qualified domain name (FQDN), e.g., representing an exact location of the client computing resource in a tree hierarchy of the domain name system (DNS), etc.); a storage size of the storage device; and/or a storage ID representing the storage device, e.g., an IQN representing an address of the storage device, an FQDN representing an exact location of the storage device in the tree hierarchy, etc.

In one embodiment, the discovery component can discover, utilizing storage device APIs of the respective APIs corresponding to the storage devices, a first group of physical network ports of the storage devices, a first group of logical network ports of the storage devices, and a first group of virtual local area networks (VLANs) that are associated with the storage devices.

Further, the discovery component can discover, utilizing network switch APIs of the respective APIs corresponding to the network switches, a second group of VLANs that are associated with the network switches, and a second group of physical network ports that are associated with the second group of VLANs that are associated with the network switches.

Furthermore, the discovery component can discover, utilizing server APIs of the respective APIs corresponding to the servers of the client networks, a third group of physical network ports of the servers, a second group of logical network ports of the servers, and a third group of VLANs that are associated with the servers.

The discovery component can further generate, using the network topology, a network graph representing a physical and a logical connectivity between the client computing resource and the storage device.

In another embodiment, the discovery component can represent the storage devices, the network switches, and the servers as respective network nodes in the network graph (e.g., storage device nodes representing the storage devices, network switch nodes representing the network switches, and server nodes representing the servers). In turn, the discovery component can associate, via the network graph, the storage device nodes with the first group of physical network ports of the storage devices, the first group of logical network ports of the storage devices, and the first group of VLANs that are associated with the storage devices.

Further, the discovery component can associate, via the network graph, the network switch nodes with the second group of VLANs that are associated with the network switches, and the second group of physical network ports that are associated with the second group of VLANs that are associated with the network switches.

Furthermore, the discovery component can associate, via the network graph, the server nodes with the third group of physical network ports of the servers, the second group of logical network ports of the servers, and the third group of VLANs that are associated with the servers.

In turn, using the network graph, the graph analysis component can determine that an available connectivity, e.g., physical or logical connectivity, between the client computing resource and the storage device has not been configured. Further, based on such determination, the configuration component can facilitate, via the respective APIs, respective configurations of the storage device, the network switches, and the client computing resource to enable the network access between the client computing resource and the storage device.

In this regard, the configuration component can modify, utilizing the respective APIs, a configuration of the storage devices, the network switches, and/or the servers to communicatively couple, via a VLAN, e.g., corresponding to the client computing resource, the storage device to the client computing resource.

For example, in one embodiment, the configuration component can create, utilizing the respective APIs, respective virtual ports on the storage device and/or the client computing device, and associate, utilizing the respective APIs, the respective virtual ports with the VLAN.

In another embodiment, the configuration component can create, utilizing the respective APIs, a virtual port on the client computing device, and create, utilizing the respective APIs, the VLAN on the virtual port.

In yet another embodiment, the configuration component can modify, utilizing the respective APIs, the configuration of the storage device, the network switches, and/or the servers based on account information corresponding to the client computing resource. In this regard, the account information represents a quality of service (QoS) of the network access, a network ID corresponding to the client network, a VLAN ID representing the VLAN, a computing asset ID representing the client computing resource, and/or a storage ID representing the storage device.

In an embodiment, the network access can comprise a fee-based access of the storage device that is based on the QoS, e.g., the QoS corresponding to a defined access time, e.g., minimum access time, a defined bandwidth/throughput of the secure network access, etc.

In one embodiment, in response to a determination that the available connectivity does not exist, the graph analysis component can send a communication directed to the client computing resource representing that the available connectivity does not exists.

In another embodiment, the security analysis component can determine, based on the network graph, whether another connectivity exists between a device that does not correspond to the client network and the storage device. Further, in response to a determination that the other connectivity exists, the security analysis component can send a communication directed to a client device representing that the other connectivity exists between the storage device and the device that does not correspond to the client network, e.g., the other connectivity representing a breach of security corresponding to the device that does not correspond to the client network.

In an embodiment, a method can comprise: receiving, by a system comprising a processor, an API request to facilitate a network access between a storage device and a device of a client network; determining, by the system using respective APIs of storage devices (comprising the storage device), network switches, and devices (comprising the device) of client networks comprising the client network, a network graph representing a physical and logical connectivity between the storage devices, the network switches, and the devices of the client networks; determining, by the system using the network graph, whether an available connectivity between the storage device and the device of the client network has been configured; and in response to determining that the available connectivity has not been configured, facilitating, using the respective APIs, a configuration of the storage device, the network switches, and/or the device of the client network to facilitate the network access between the storage device and the device of the client network.

In another embodiment, the receiving comprises receiving the API request comprising information representing a storage ID of the storage device, a VLAN ID of a VLAN coupled to the device of the client network, and an account ID corresponding to the device of the client network. Further, the facilitating the configuration can comprise facilitating the configuration based on the storage ID, the VLAN ID, and the account ID.

In yet another embodiment, a machine-readable storage medium can comprise executable instructions that, when executed by a system comprising a processor (e.g., cloud service provider system 110), facilitate performance of operations, comprising: in response to receiving an API request to facilitate a protected network access, by a client device, of a storage device, learning, using respective application programming interfaces (APIs) of storage devices comprising the storage device, network switches, and client devices comprising the client device, a network connectivity between the client device and the storage device to obtain a learned connectivity, and building, based on the learned connectivity, a network graph representing a physical connectivity and a logical connectivity between the client device and the storage device; and in response to determining, based on the network graph, that an available connectivity between the client device and the storage device has not been configured, configuring, using the respective APIs, at least one of the storage device, the network switches, or the client device to facilitate the protected network access.

In an embodiment, the configuring comprises communicatively coupling, via at least one switch of the network switches using the respective APIs, the storage device to a VLAN of the client device.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

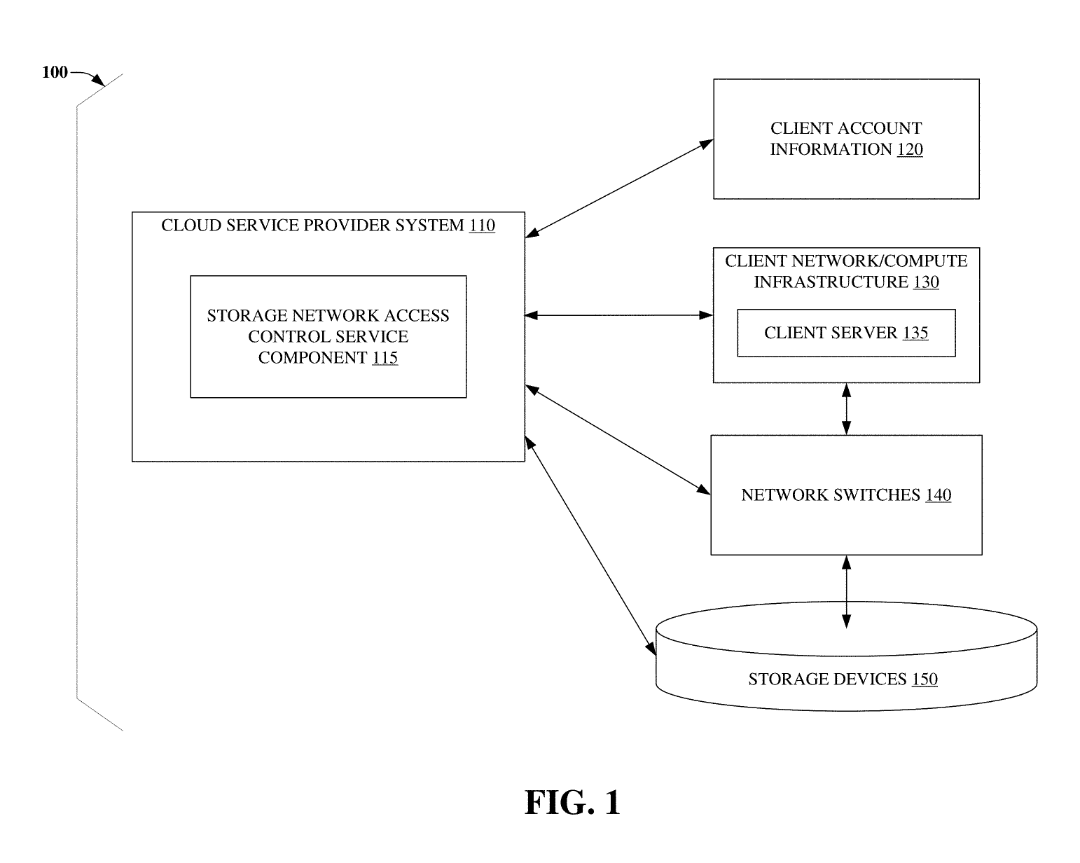

Referring now to FIGS. 1-3, block diagrams (100, 200, 300) of a network storage environment, a storage network access control service component, and a storage network environment having different storage zones and client networks are illustrated, respectively, in accordance with various embodiments. Storage network access control service component 115 of cloud service provider system 110 can dynamically manage, on behalf of a network service provider (e.g., a cloud-based storage service provider) using open source and/or vendor specific APIs, networks (e.g., 100, 300, 310, 315, etc.) to facilitate a network access, by a computing device (e.g., 135, 335, a virtual machine, etc.) via network switches (e.g., 140, 317), of a storage device of storage devices 150—the storage device comprising, e.g., a block storage device, a storage appliance, a virtual storage appliance, a resource of the storage appliance, e.g., a storage block device, a file storage device, a storage file share, etc.

In embodiment(s), the storage device can comprise: a block storage device that is a storage area network (SAN) accessible storage device that can be accessed via protocols including Internet Small Computer System Interface iSCSI, fibre channel (FC), infiniband, etc.; a virtual storage appliance, e.g., a storage appliance from which block and/or file storage device(s) can be provisioned; a file storage device, e.g., a network-attached storage (NAS) folder or volume that is accessible via file protocols, e.g., network file system (NFS), server message block (SMB), etc.

Storage network access control service component 115 can comprise discovery component 210, graph analysis component 220, configuration component 230, and security analysis component 240. In this regard, discovery component 210 can discover a network topology of a network/network storage environment (e.g., 100, 300, 310, 315, etc.) utilizing APIs, e.g., of respective modules, plugins, adapters that have been loaded, installed, etc. in a memory (not shown) of cloud service provider system 110, e.g., during a “run time” of an application (e.g., comprising storage network access control service component 115); using script file(s), e.g., comprising a representational state transfer (REST/RESTful) based API, which have been installed in a directory (not shown) of a file system (not shown) of cloud service provider system 110, etc.

A first group of the APIs can correspond to, be included in, etc. storage management plugins 302, which correspond to storage devices/appliances (342, 344, 346, 352, 354, 356, 362, 364, 366) of respective storage zones (340, 350, 360). In this regard, a storage zone can comprise a group/logical grouping of storage devices representing similar properties of the storage devices, e.g., with respect to a location of the storage devices, a performance of the storage devices, a client of the network service provider, a vendor of the storage devices, etc. In one example embodiment, each storage zone can be physically located in different data centers, and connected to different storage fabrics/networks (e.g., 100, 300). In another example, embodiment, a cloud service provider can assign a storage device to a storage zone based on a type, a location, a performance, etc. of the storage device.

A second group of the APIs can correspond to, be included in, etc. network management plugins 304, which correspond to network switches (140, 317) of respective networks (310, 315). Further, a third group of the APIs can correspond to, be included in, etc. server management plugins 306, which correspond to computing devices, servers, virtual machines, etc. (135, 335) of corresponding client networks/compute infrastructures (130, 330).

In one embodiment, discovery component 210 can discover the network topology of the network/network storage environment in response to receiving, via API 301, an API request, e.g., from the client of the network service provider, to facilitate an access, a network access, a secure network access, etc. between the computing device and the storage device.

In other embodiment(s), the API request can comprise an account ID corresponding to the computing device; a network ID corresponding to the client network, e.g., a VLAN ID representing a VLAN of the client network, an IP address corresponding to the computing device, etc.; a compute asset ID representing the client device (e.g., an IQN representing an address of the client computing resource, an FQDN, e.g., representing an exact location of the client computing resource in a tree hierarchy of the DNS, etc.); a storage size of the storage device; and/or a storage ID representing the storage device, e.g., an IQN representing an address of the storage device, an FQDN representing an exact location of the storage device in the tree hierarchy, etc.

In one embodiment, discovery component 210 can discover, utilizing storage device APIs of the respective APIs corresponding to the storage devices, a first group of physical network ports of the storage devices, a first group of logical network ports of the storage devices, and a first group of VLANs that are associated with the storage devices.

Further, discovery component 210 can discover, utilizing network switch APIs of the respective APIs corresponding to the network switches, a second group of VLANs that are associated with the network switches, and a second group of physical network ports that are associated with the second group of VLANs that are associated with the network switches.

Furthermore, discovery component 210 can discover, utilizing server APIs of the respective APIs corresponding to the computing devices, servers, virtual machines, etc. of the corresponding client networks/compute infrastructures, a third group of physical network ports of the computing devices, etc., a second group of logical network ports of the computing devices, etc., and a third group of VLANs that are associated with the computing devices, etc.

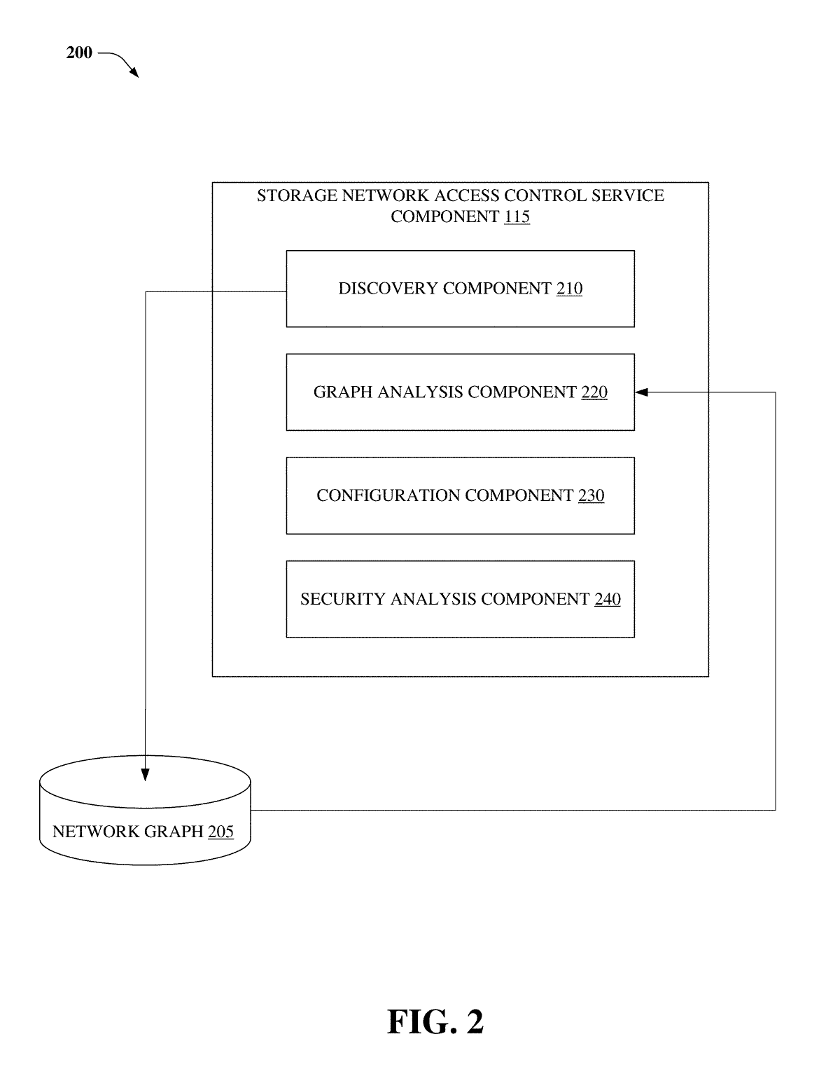

Referring now to FIG. 2, discovery component 210 can further generate, using the network topology, network graph 205 representing a physical and a logical connectivity between the computing device and the storage device. In an embodiment, discovery component 210 can represent the storage devices, the network switches, and the computing devices, etc. as respective network nodes in network graph 205 (e.g., storage device nodes representing the storage devices, network switch nodes representing the network switches, and server nodes representing the computing devices, etc.). In turn, discovery component 210 can associate, via network graph 205, the storage device nodes with the first group of physical network ports of the storage devices, the first group of logical network ports of the storage devices, and the first group of VLANs that are associated with the storage devices.

Further, discovery component 210 can associate, via network graph 205, the network switch nodes with the second group of VLANs that are associated with the network switches, and the second group of physical network ports that are associated with the second group of VLANs that are associated with the network switches.

Furthermore, discovery component 210 can associate, via network graph 205, the server nodes with the third group of physical network ports of the servers, the second group of logical network ports of the servers, and the third group of VLANs that are associated with the servers.

In turn, using network graph 205, graph analysis component 220 can determine that an available, e.g., physical or logical, connectivity between the computing device and the storage device has not been configured. Further, based on such determination, configuration component 230 can facilitate, via the respective APIs, respective configurations of the storage device, the network switches, and the computing device to enable the network access between the computing device and the storage device.

In embodiment(s), based on a determination, by graph analysis component 220, that the available connectivity between the computing device and the storage device has not been configured, configuration component 230 can modify, utilizing the respective APIs, a configuration of the storage devices, the network switches, and/or the computing devices to communicatively couple, via a VLAN, e.g., corresponding to the computing device, the storage device to the computing device.

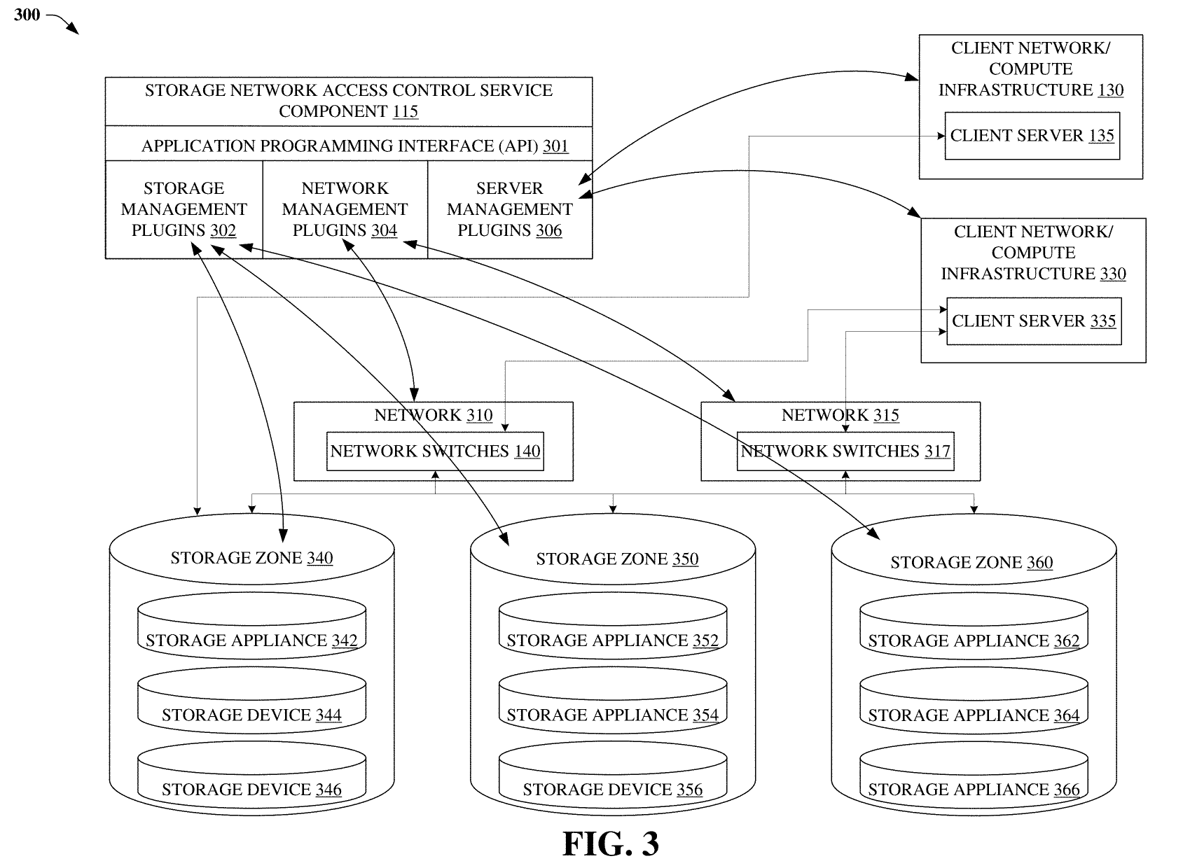

For example, and now referring to FIG. 3, lines between storage zones (340, 350, 360), network switches (140, 317), and client servers (135, 335) represent an available connectivity between the client server and the storage zone that has not been configured. In this regard, where no lines connect the client server, via a network, to the storage zone, the available connectivity between the client server and the storage zone does not exist, e.g., the client server cannot be communicatively coupled to the storage zone, e.g., client server 135 cannot be communicatively coupled to storage zone 350 or 360. In an embodiment, based on such determination by graph analysis component 220, graph analysis component 220 can send a communication directed to a user corresponding to the client server indicating the available connectivity does not exist.

In one embodiment, configuration component 230 can create, utilizing the respective APIs, respective virtual ports on the storage device and/or the computing device, and associate, utilizing the respective APIs, the respective virtual ports with the VLAN.

In another embodiment, configuration component 230 can create, utilizing the respective APIs, a virtual port on the client computing device, and create, utilizing the respective APIs, the VLAN on the virtual port.

In yet another embodiment, configuration component 230 can modify, utilizing the respective APIs, the configuration of the storage devices, the network switches, and/or the computing devices—based on client account information 120 corresponding to the computing device. In this regard, client account information 120 represents a QoS of the network access, a network ID corresponding to the client network, a VLAN ID representing the VLAN, a computing asset ID representing the computing device, and/or a storage ID representing the storage device.

In an embodiment, the network access can comprise a fee-based access of the storage device that is based on the QoS, e.g., the QoS corresponding to a defined access time, e.g., minimum access time, a defined bandwidth/throughput of the network access, etc.

In one embodiment, based on a determination, by graph analysis component 220, that the available connectivity between the computing device and the storage device has not been configured, configuration component 230 can generate, utilizing the respective APIs, reports, scripts, etc. representing storage devices, network switches, and/or computing devices that should be configured, e.g., and how they should be configured, to facilitate the network access between the computing device and the storage device.

In another embodiment, security analysis component 240 can determine, based on the network graph, whether another connectivity exists between a device, which does not correspond to the client network, and the storage device. Further, in response to a determination that the other connectivity exists, security analysis component 240 can send a communication directed to a client computing device representing that the other connectivity exists between the device that does not correspond to the client network and the storage device, e.g., the other connectivity representing a breach of security corresponding to the device that does not correspond to the client network.

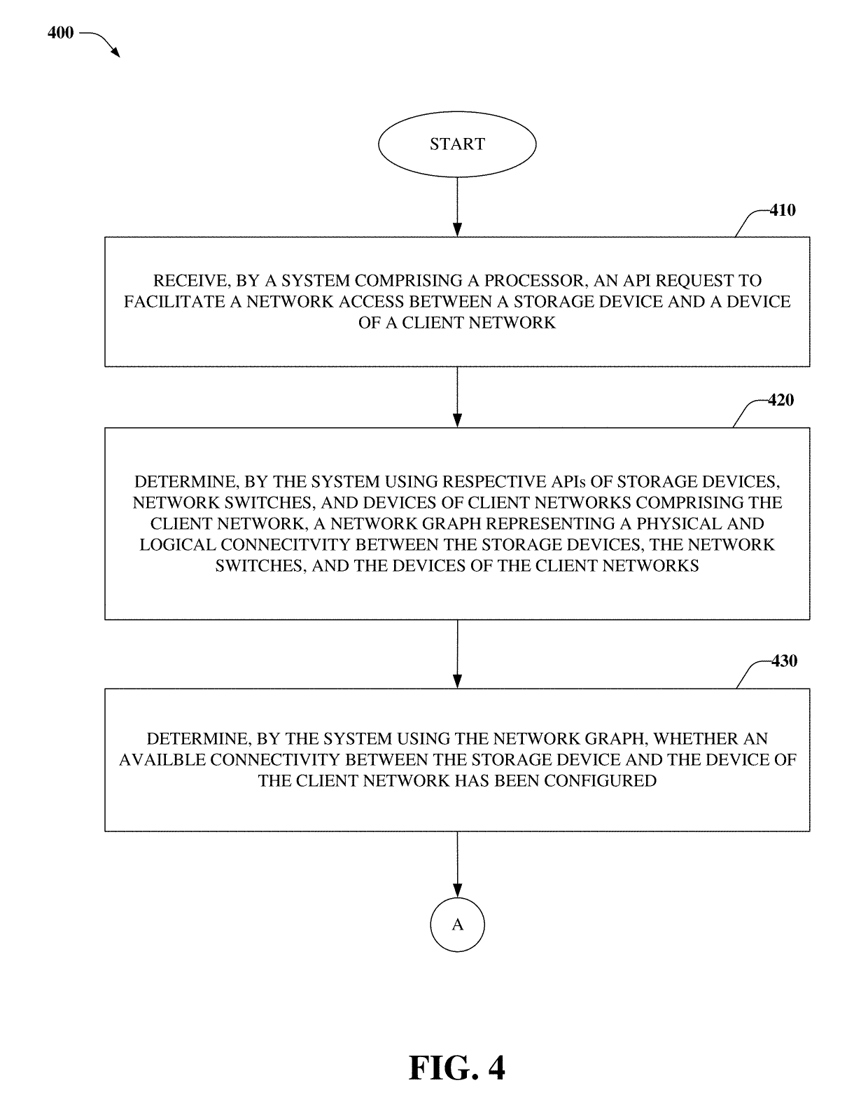

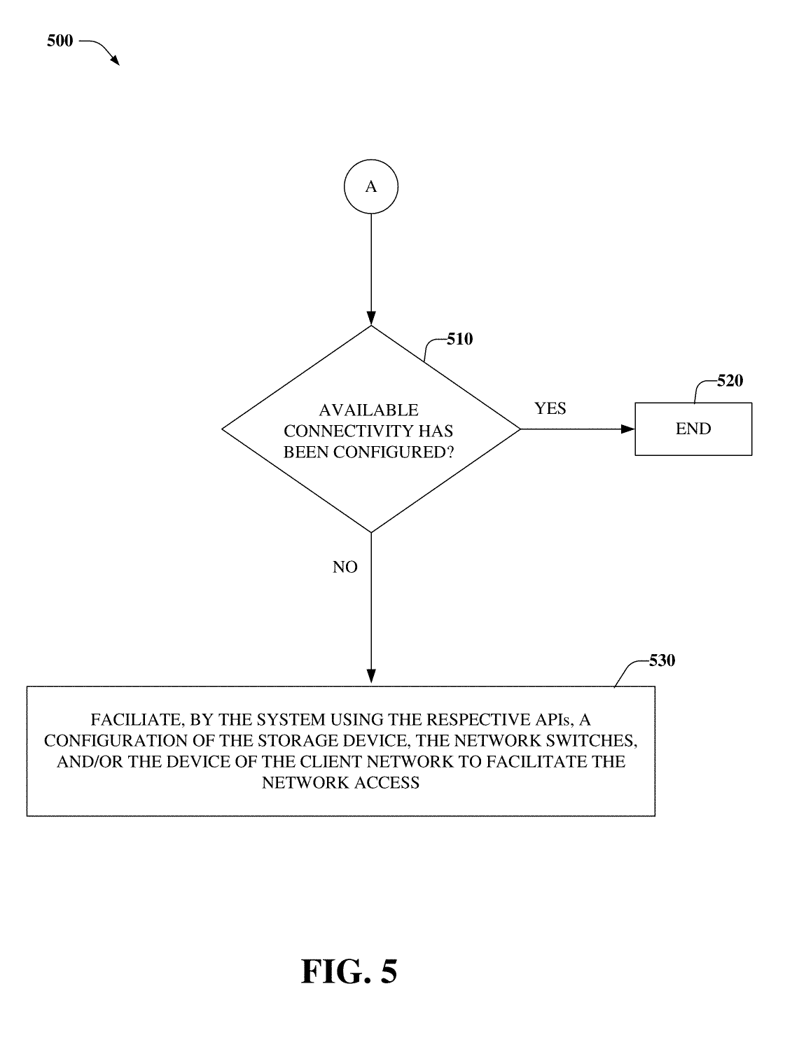

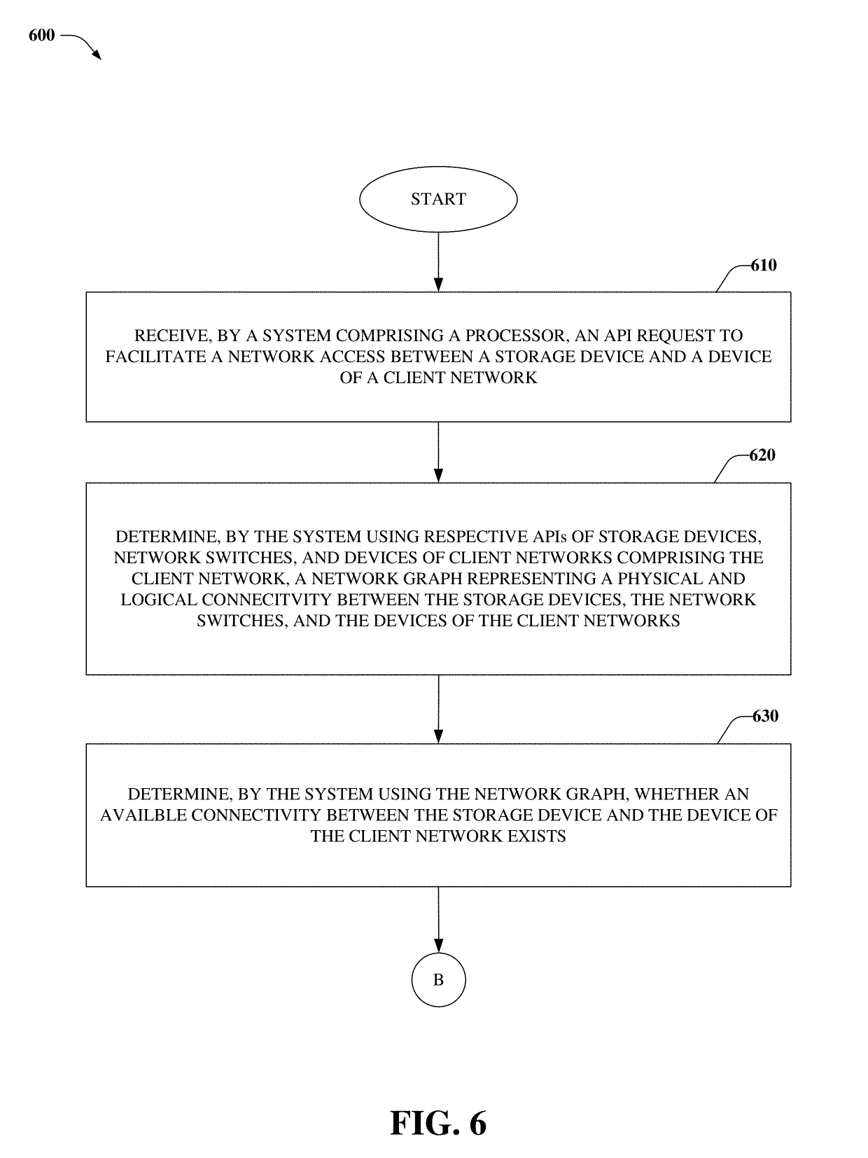

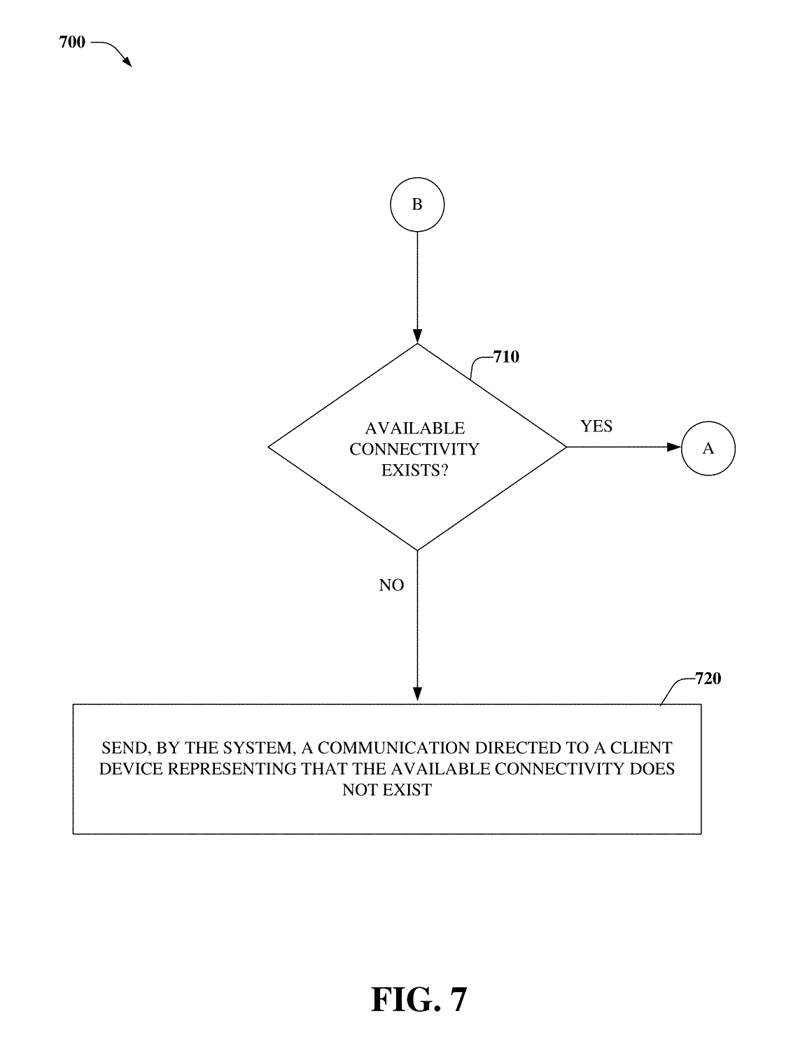

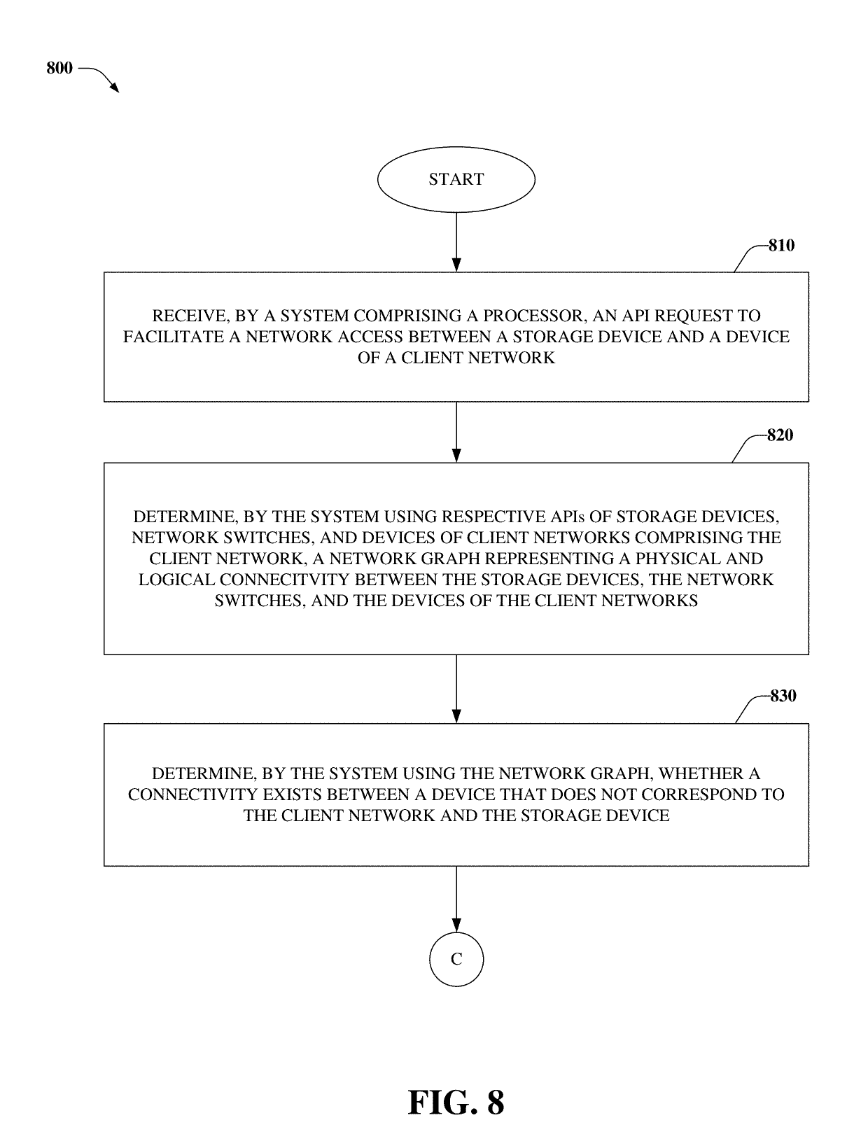

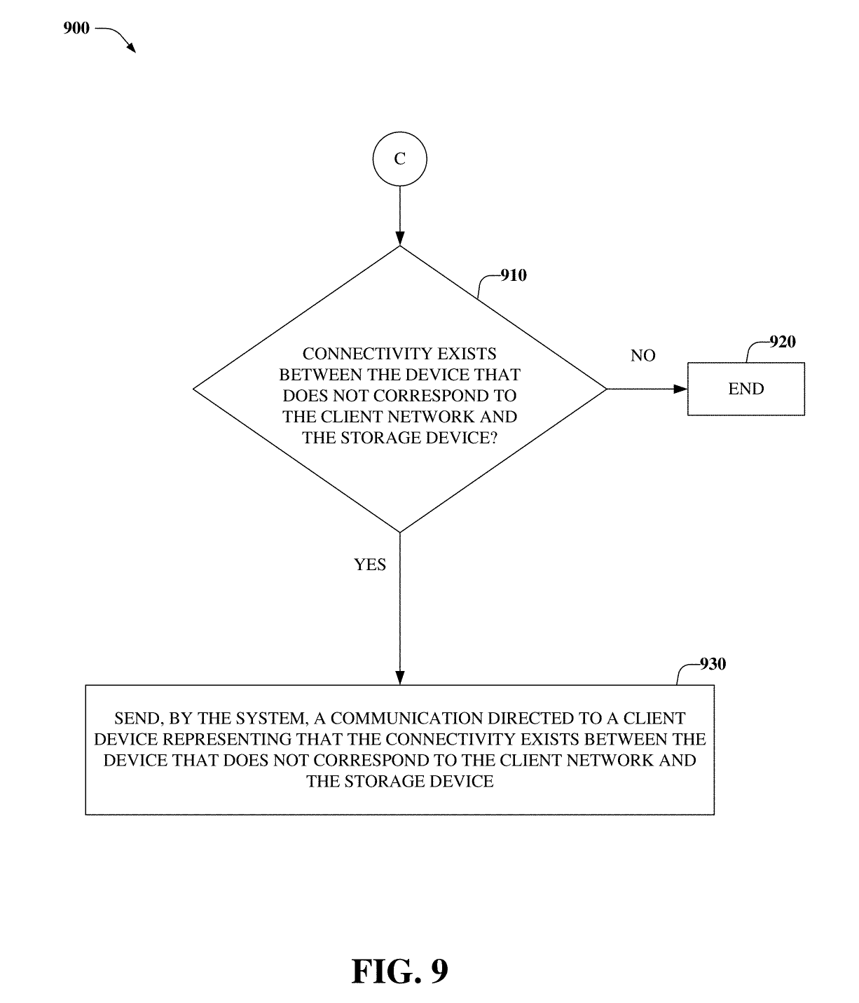

FIGS. 4-9 illustrate methodologies in accordance with the disclosed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIGS. 4-9, processes (400-900) associated with a storage network access control service component, e.g., 115, are illustrated, in accordance with various embodiments. At 410, an API request to facilitate a network access between a storage device and a device of a client network can be received.

At 420, a network graph representing a physical and logical connectivity between storage devices, network switches, and devices of client networks comprising the client network can be determined using respective APIs of the storage devices, the network switches, and the devices of the client networks.

At 430, a determination can be made, using the network graph, as to whether an available connectivity between the storage device and the device of the client network has been configured.

Flow continues from 430 to 510, at which, in response to a determination that the available connectivity has been configured, the process ends at 520; otherwise flow continues to 530, at which a configuration of the storage device, the network switches, and/or the device of the client network can be facilitated, using the respective APIs, to facilitate the network access.

At 610, an API request to facilitate a network access between a storage device and a device of a client network can be received. At 620, a network graph representing a physical and logical connectivity between storage devices, network switches, and devices of client networks comprising the client network can be determined using respective APIs of the storage devices, the network switches, and the devices of the client networks.

At 630, a determination can be made, using the network graph, as to whether an available connectivity between the storage device and the device of the client network exists.

Flow continues from 630 to 710, at which, in response to a determination that the available connectivity exists, the process returns to 510; otherwise flow continues to 720, at which a communication is sent, directed, etc. to a client device representing that the available connectivity does not exist.

At 810, an API request to facilitate a network access between a storage device and a device of a client network can be received. At 820, a network graph representing a physical and logical connectivity between storage devices, network switches, and devices of client networks comprising the client network can be determined using respective APIs of the storage devices, the network switches, and the devices of the client networks.

At 830, a determination can be made, using the network graph, as to whether a connectivity exists between a device that does not correspond to the client network and the storage device.

Flow continues from 830 to 910, at which, in response to a determination that the connectivity does not exist between the device that does not correspond to the client network and the storage device, the process ends at 920; otherwise flow continues to 930, at which a communication is sent, directed, etc. to a client device representing that the connectivity exists between the device that does not correspond to the client network and the storage device.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “storage appliance,” “storage device”, “data store,” “data storage,” “storage medium,” “storage media,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in a storage device (e.g., 342, 344, 346, 352, 354, 356, 362, 364, 366), cloud service provider system 110, client account information 120, non-volatile memory 1022 (see below), disk storage 1024 (see below), and/or memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

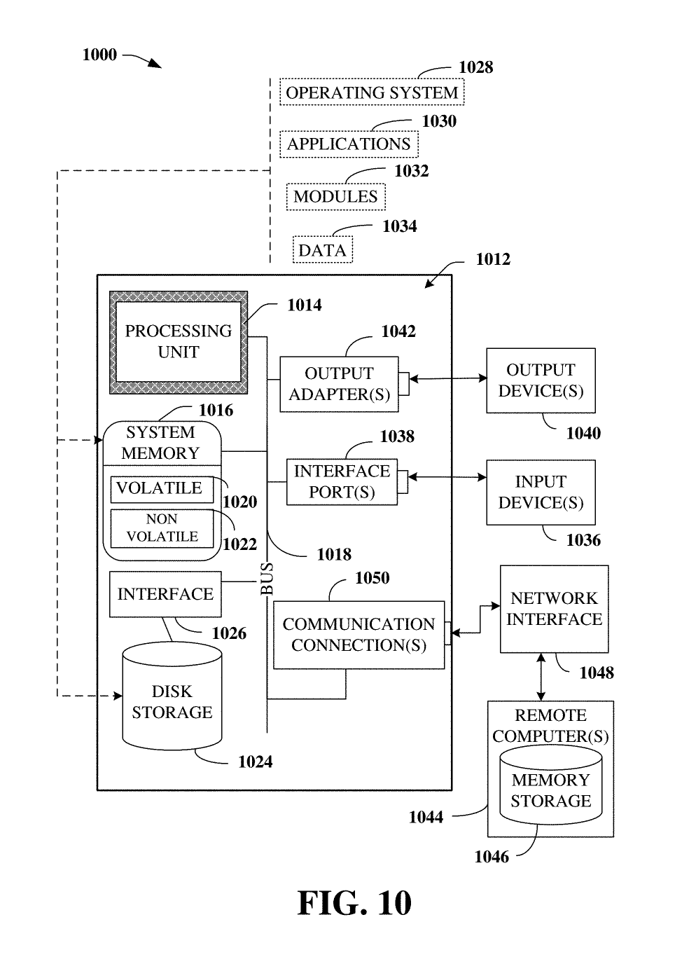

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the subject innovation also can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 10, a block diagram of a computing system 1000 operable to execute the disclosed components, systems, devices, methods, processes, etc., e.g., corresponding to 110, 115, etc. is illustrated, in accordance with an embodiment. Computer 1012 includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), Small Computer Systems Interface (SCSI), and/or controller area network (CAN) bus used in vehicles.

System memory 1016 includes volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 can also include removable/non-removable, volatile/non-volatile computer storage media, networked attached storage (NAS), e.g., SAN storage, etc. FIG. 10 illustrates, for example, disk storage 1024. Disk storage 1024 includes, but is not limited to, devices like a magnetic disk drive, floppy disk drive, tape drive, Jaz drive, Zip drive, LS-110 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

It is to be appreciated that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be appreciated that the disclosed subject matter can be implemented with various operating systems or combinations of operating systems.

A user can enter commands or information into computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1014 through system bus 1018 via interface port(s) 1038. Interface port(s) 1038 include, for example, a serial port, a parallel port, a game port, a universal serial bus (USB), a wireless based port, e.g., WiFi, Bluetooth®, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040, like display devices, light projection devices, monitors, speakers, and printers, among other output devices 1040, which use special adapters. Output adapters 1042 include, by way of illustration and not limitation, video and sound devices, cards, etc. that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically and/or wirelessly connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, wireless modems, ISDN adapters, and Ethernet cards.

The computer 1012 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1012 can connect to other devices/networks by way of antenna, port, network interface adaptor, wireless access point, modem, and/or the like.

The computer 1012 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This includes at least WiFi and Bluetooth® wireless technologies. Thus, the communication can be a predefined structure as with a conventional network or simply an ad hoc communication between at least two devices.

WiFi allows connection to the Internet from a desired location (e.g., a vehicle, couch at home, a bed in a hotel room, or a conference room at work, etc.) without wires. WiFi is a wireless technology similar to that used in a cell phone that enables such devices, e.g., mobile phones, computers, etc., to send and receive data indoors and out, anywhere within the range of a base station. WiFi networks use radio technologies called IEEE 802.11 (a, b, g, etc.) to provide secure, reliable, fast wireless connectivity. A WiFi network can be used to connect communication devices (e.g., mobile phones, computers, etc.) to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

Further, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art.

As utilized herein, terms “system,” “component”, “service”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used, via storage network access control service component 115, e.g., to determine—using respective APIs of storage devices, network switches, and devices of client networks—a network graph representing a physical and logical connectivity between the storage devices, the network switches, and the devices of client networks; to determine, using the network graph, whether an available connectivity between a storage device of the storage devices and a device of the devices of the client networks exists; and to configure, using the respective APIs, the storage devices, the network switches, and/or the device to facilitate a network access between the storage device and the device, etc.

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via reception, by a file system (e.g., cloud service provider system 110), of an API request to facilitate an access between a client device and a storage device—the API request comprising an account ID corresponding to the client device, a network ID corresponding to a client network associated with the client device, a compute asset ID representing the client device, a storage size of the storage device, and/or a storage ID of the storage device; via discovery, by the file system, of a network topology using respective APIs of network switches, servers of client networks, and storage devices, etc. For example, support vector machines can be configured via a learning or training phase within a classifier constructor and feature selection module, component, etc. Thus, the classifier(s) can be used by an artificial intelligence system to automatically learn and perform a number of functions, e.g., performed by storage network access control service component 115, etc.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a first memory that stores executable instructions that, when executed by the processor, facilitate performance of operations, comprising:
in response to receiving an application programming interface (API) request to facilitate a secure network access between a client computing resource of a client network and a storage device,
discovering a network topology utilizing respective application programming interfaces (APIs) of network switches, servers of client networks comprising the client network, and storage devices comprising the storage device, and
generating, using the network topology, a network graph representing a physical and logical connectivity between the client computing resource and the storage device, wherein the client computing resource comprises a server of the servers; and
in response to determining, based on the network graph, that an available connectivity between the client computing resource and the storage device has not been configured, facilitating, via the respective APIs, respective configurations of at least one of the storage device, the network switches, or the client computing resource to enable the secure network access between the client computing resource and the storage device.

2. The system of claim 1, wherein the API request comprises at least one of an account identifier (ID) corresponding to the client computing resource, a network ID corresponding to the client network, a compute asset ID representing the client computing resource, a storage size of the storage device, or a storage ID representing the storage device.

3. The system of claim 2, wherein the network ID comprises at least one of a virtual local area network (VLAN) ID representing a VLAN or an Internet protocol (IP) address corresponding to the VLAN, and wherein facilitating the respective configurations comprises:
communicatively coupling, via the VLAN, the client computing resource to the storage device.

4. The system of claim 1, wherein the storage device comprises at least one of a block storage device, a virtual storage appliance, or a file storage device.

5. The system of claim 1, wherein discovering the network topology comprises:
discovering, utilizing storage device APIs of the respective APIs corresponding to the storage devices, a first group of physical network ports of the storage devices, a first group of logical network ports of the storage devices, and a first group of virtual local area networks (VLANs) that are associated with the storage devices.

6. The system of claim 5, wherein the operations further comprise:
discovering, utilizing network switch APIs of the respective APIs corresponding to the network switches, a second group of VLANs that are associated with the network switches; and
discovering, utilizing the network switch APIs, a second group of physical network ports that are associated with the second group of VLANs that are associated with the network switches.

7. The system of claim 6, wherein the operations further comprise:
discovering, utilizing server APIs of the respective APIs corresponding to the servers of the client networks, a third group of physical network ports of the servers, a second group of logical network ports of the servers, and a third group of VLANs that are associated with the servers.

8. The system of claim 7, wherein generating the network graph comprises:
representing the storage devices, the network switches, and the servers as respective network nodes of the network graph.

9. The system of claim 8, wherein the operations further comprise:
associating, via the network graph, storage device nodes of the respective network nodes with the first group of physical network ports of the storage devices, the first group of logical network ports of the storage devices, and the first group of VLANs that are associated with the storage devices;
associating, via the network graph, network switch nodes of the respective network nodes with the second group of VLANs that are associated with the network switches, and the second group of physical network ports that are associated with the second group of VLANs that are associated with the network switches; and
associating, via the network graph, server nodes of the respective network nodes with the third group of physical network ports of the servers, the second group of logical network ports of the servers, and the third group of VLANs that are associated with the servers.

10. The system of claim 1, wherein the facilitating the respective configurations comprises:
modifying, utilizing the respective APIs, a configuration of at least one of the storage devices, the network switches, or the servers to communicatively couple, via a virtual local area network (VLAN), the client computing resource to the storage device.

11. The system of claim 10, wherein the modifying comprises:
creating, utilizing the respective APIs, respective virtual ports on at least one of the storage device or the client computing device; and
associating, utilizing the respective APIs, the respective virtual ports with the VLAN.

12. The system of claim 10, wherein the modifying comprises:
creating, utilizing the respective APIs, a virtual port on the client computing device; and
creating, utilizing the respective APIs, the VLAN on the virtual port.

13. The system of claim 10, wherein the modifying comprises:
based on account information corresponding to the client computing resource, modifying, utilizing the respective APIs, the configuration, and wherein the account information represents at least one of a quality of service (QoS) of the secure network access, a network identifier (ID) corresponding to the client network, a VLAN ID representing the VLAN, a computing asset ID representing the client computing resource, or a storage ID representing the storage device.

14. The system of claim 13, wherein the secure network access comprises a fee-based access of the storage device that is based on the QoS, and wherein the QoS corresponds to at least one of a defined access time of the secure network access or a defined bandwidth of the secure network access.

15. The system of claim 1, wherein the operations further comprise:
in response to determining that the available connectivity does not exist, sending a communication directed to the client computing resource representing that the available connectivity does not exists.

16. The system of claim 1, wherein the available connectivity is a first connectivity, and wherein the operations further comprise:
based on the network graph, determining whether a second connectivity exists between a device that does not correspond to the client network and the storage device; and
in response to determining that the second connectivity exists, sending a communication directed to a client device representing that the second connectivity exists between the device that does not correspond to the client network and the storage device.

17. A method, comprising:
receiving, by a system comprising a processor, an application programming interface (API) request to facilitate a network access between a storage device and a device of a client network;
determining, by the system using respective application programming interfaces (APIs) of storage devices, network switches, and devices of client networks comprising the client network, a network graph representing a physical and logical connectivity between the storage devices, the network switches, and the devices of the client networks, wherein the storage devices comprise the storage device, and wherein the devices comprise the device of the client network;
determining, by the system using the network graph, whether an available connectivity between the storage device and the device of the client network has been configured; and
in response to determining that the available connectivity has not been configured, facilitating, using the respective APIs, a configuration of at least one of the storage device, the network switches, or the device of the client network to facilitate the network access between the storage device and the device of the client network.

18. The method of claim 17, wherein the receiving comprises:
receiving the API request comprising information representing a storage identifier (ID) of the storage device, a virtual local area network (VLAN) ID of a VLAN coupled to the device of the client network, and an account identifier (ID) corresponding to the device of the client network, and wherein the facilitating the configuration comprises facilitating the configuration based on the storage ID, the VLAN ID, and the account ID.

19. A machine-readable storage medium, comprising executable instructions that, when executed by a system comprising a processor, facilitate performance of operations, comprising:
in response to receiving an application programming interface (API) request to facilitate a protected network access, by a client device, of a storage device,
learning, using respective application programming interfaces (APIs) of storage devices comprising the storage device, network switches, and client devices comprising the client device, a network connectivity between the client device and the storage device to obtain a learned connectivity, and
building, based on the learned connectivity, a network graph representing a physical connectivity and a logical connectivity between the client device and the storage device; and
in response to determining, based on the network graph, that an available connectivity between the client device and the storage device has not been configured, configuring, using the respective APIs, at least one of the storage device, the network switches, or the client device to facilitate the protected network access.

20. The machine-readable storage medium of claim 19, wherein the configuring comprises:
communicatively coupling, via at least one switch of the network switches using the respective APIs, the storage device to a VLAN of the client device.
